(19) United States
(12) Patent Application Publication
(10) Pub. No.: US 2025/0265358 A1
(43) Pub. Date: Aug. 21, 2025

(54) ITERATIVE ANOMALY ANALYSIS AND DETECTION FOR USER ENTITLEMENT DATA

(71) Applicant: HSBC GLOBAL SERVICES (UK) LIMITED, London (GB)

(72) Inventor: Jonathan Michael PUGH, London (GB)

(21) Appl. No.: 19/201,128

(22) Filed: May 7, 2025

(51) Int. Cl. G06F 21/60

(52) U.S. Cl. CPC G06F 21/604; G06F 2221/2113; G06F 2221/2141

(57) ABSTRACT

This disclosure provides systems, methods, and devices that enhance the analysis of user entitlements using iterative anomaly detection. In one aspect, a method is provided wherein a plurality of entitlement assignments associated with a plurality of users are received. The plurality of entitlement assignments are repeatedly processed using an anomaly detection module for a plurality of iterations to determine a plurality of anomaly measures, where each respective anomaly measure corresponds to a particular iteration and a particular entitlement assignment. A plurality of combined anomaly measures are determined based on the plurality of anomaly measures that each correspond to a respective entitlement assignment and may be determined based on anomaly measures corresponding to the respective entitlement assignment. An entitlement recommendation may be determined based on at least a subset of the combined anomaly measures. Other aspects are provided.

### BACKGROUND

Computer systems and networks within organizations often contain sensitive data and resources. Controlling user access to these resources is a fundamental aspect of information technology security and operations. Access control mechanisms typically rely on assigning specific permissions or entitlements to users, which define the actions they are authorized to perform, such as accessing certain files, using specific applications, or administering system components. In large organizations, the number of users, resources, and corresponding entitlements can be substantial and complex, spanning numerous different systems and platforms. Managing these entitlements effectively is often necessary to maintain system security, comply with regulations, and ensure operational efficiency.

### SUMMARY

The present disclosure describes techniques for analyzing user entitlement assignments within an organization. A computing device may receive entitlement assignments and associated user profile data from a data repository. An anomaly detection module, potentially using machine learning models like Isolation Forest, may repeatedly process these assignments over a plurality of iterations to determine individual anomaly measures for each assignment in each iteration. These individual measures may then be combined (e.g., summed, averaged, or counted) for each entitlement assignment across the iterations to determine a more robust combined anomaly measure. Based on these combined anomaly measures, the computing device may determine an entitlement recommendation, which could include identifying potentially inappropriate entitlements, suggesting missing entitlements based on peer group analysis (inliers), generating confidence scores, or triggering downstream actions like alerts or automated remediation.

In a first aspect, a method is provided that includes receiving, by a computing device, a plurality of entitlement assignments associated with a plurality of users from a data repository; repeatedly processing, by the computing device, the plurality of entitlement assignments using an anomaly detection module for a plurality of iterations, to determine a plurality of anomaly measures, where each respective anomaly measure of the plurality of anomaly measures corresponds to a respective iteration of the anomaly detection module and a respective entitlement assignment of the plurality of entitlement assignments; determining, by the computing device, a plurality of combined anomaly measures based on the plurality of anomaly measures, where each respective combined anomaly measure of the plurality of combined anomaly measures corresponds to a respective entitlement assignment of the plurality of entitlement assignments and is determined based on anomaly measures of the plurality of anomaly measures that correspond to the respective entitlement assignment; and determining an entitlement recommendation based on at least a subset of the combined anomaly measures.

In a second aspect according to the first aspect, repeatedly processing the plurality of entitlement assignments for the plurality of iterations includes for each respective iteration of the plurality of iterations, applying the anomaly detection module to the plurality of entitlement assignments to determine a corresponding subset of the plurality of anomaly measures, where each respective anomaly measure of the corresponding subset is associated with the respective iteration and a respective entitlement assignment of the plurality of entitlement assignments.

In a third aspect according to the second aspect, the anomaly detection module includes one or more machine learning models, and where applying the anomaly detection module to the plurality of entitlement assignments during each respective iteration includes providing the plurality of entitlement assignments as input to the one or more machine learning models.

In a fourth aspect according to any one of the second aspect through the third aspect, applying the anomaly detection module for the plurality of iterations includes performing a first iteration by applying the anomaly detection module to the plurality of entitlement assignments to determine a first subset of the plurality of anomaly measures, where each anomaly measure in the first subset corresponds to the first iteration and a respective entitlement assignment of the plurality of entitlement assignments; and performing a second iteration by applying the anomaly detection module to the plurality of entitlement assignments to determine a second subset of the plurality of anomaly measures, where each anomaly measure in the second subset corresponds to the second iteration and a respective entitlement assignment of the plurality of entitlement assignments.

In a fifth aspect according to any one of the third aspect through the fourth, the one or more machine learning models include an unsupervised anomaly detection model.

In a sixth aspect according to the fifth aspect, the unsupervised anomaly detection model includes an Isolation Forest model.

In a seventh aspect according to any one of the first aspect through the sixth aspect, determining each respective combined anomaly measure includes combining a corresponding subset of the plurality of anomaly measures, the corresponding subset including anomaly measures determined across the plurality of iterations for the respective entitlement assignment.

In an eighth aspect according to the seventh aspect, determining the plurality of combined anomaly measures includes determining a first combined anomaly measure for a first entitlement assignment of the plurality of entitlement assignments based on a first subset of the plurality of anomaly measures, where the first subset includes anomaly measures associated with the first entitlement assignment determined across the plurality of iterations; and determining a second combined anomaly measure for a second entitlement assignment of the plurality of entitlement assignments based on a second subset of the plurality of anomaly measures, where the second subset includes anomaly measures associated with the second entitlement assignment determined across the plurality of iterations.

In a ninth aspect according to any one of the seventh aspect and the eighth aspect, combining the corresponding subset of the plurality of anomaly measures includes determining a sum of the anomaly measures in the corresponding subset; determining an average of the anomaly measures in the corresponding subset; determining a count of anomaly measures within the corresponding subset that indicate the respective entitlement assignment was identified as anomalous; or a combination thereof.

In a tenth aspect according to any one of the first aspect through the ninth aspect, the method further includes receiving, by the computing device, user profile data associated with the plurality of users from the data repository, the user profile data including a plurality of user features; and where repeatedly processing the plurality of entitlement assignments further includes processing the plurality of entitlement assignments and the plurality of user features using the anomaly detection module to determine the plurality of anomaly measures.

In an eleventh aspect according to the tenth aspect, the plurality of user features includes one or more of: a user role, a user team membership, a user manager identity, a user business unit affiliation, or a user location.

In a twelfth aspect according to any one of the tenth aspect through the eleventh aspect, the method further includes determining feature weights for different user features of the plurality of user features; and where repeatedly processing the plurality of entitlement assignments using the anomaly detection module includes applying the feature weights during the processing.

In a thirteenth aspect according to any one of the first aspect through the twelfth aspect, the plurality of iterations includes a predetermined number of iterations, N, where N is greater than one.

In a fourteenth aspect according to any one of the first aspect through the thirteenth aspect, the method further includes determining, based on the combined anomaly measures, one or more inlier entitlement assignments that are identified as non-anomalous across the plurality of iterations; and determining a suggestion for a missing entitlement for a target user based on comparing entitlement assignments of the target user to the one or more inlier entitlement assignments associated with peer users.

In a fifteenth aspect according to any one of the first aspect through the fourteenth aspect, the method further includes generating an alert notification based on the entitlement recommendation; triggering enhanced monitoring for user activity associated with an entitlement assignment identified in the entitlement recommendation; requiring step-up authentication for access related to an entitlement assignment identified in the entitlement recommendation; initiating an automated remediation action based on the entitlement recommendation, the automated remediation action including at least one of provisioning or de-provisioning an entitlement assignment identified in the entitlement recommendation; generating a report detailing entitlement assignments identified based on the combined anomaly measures; or a combination thereof.

In a sixteenth aspect according to any one of the first aspect through the fifteenth aspect, determining the entitlement recommendation is performed in response to receiving an access request for a new entitlement assignment, the method further includes providing an indication of whether the requested new entitlement assignment is anomalous based on the entitlement recommendation.

In a seventeenth aspect, a system is provided that includes a processor; and a memory storing instructions which, when executed by the processor, cause the processor to perform operations including: receiving, by a computing device, a plurality of entitlement assignments associated with a plurality of users from a data repository; repeatedly processing, by the computing device, the plurality of entitlement assignments using an anomaly detection module for a plurality of iterations, to determine a plurality of anomaly measures, where each respective anomaly measure of the plurality of anomaly measures corresponds to a respective iteration of the anomaly detection module and a respective entitlement assignment of the plurality of entitlement assignments; determining, by the computing device, a plurality of combined anomaly measures based on the plurality of anomaly measures, where each respective combined anomaly measure of the plurality of combined anomaly measures corresponds to a respective entitlement assignment of the plurality of entitlement assignments and is determined based on anomaly measures of the plurality of anomaly measures that correspond to the respective entitlement assignment; and determining an entitlement recommendation based on at least a subset of the combined anomaly measures.

In an eighteenth aspect according to the seventeenth aspect, repeatedly processing the plurality of entitlement assignments for the plurality of iterations includes for each respective iteration of the plurality of iterations, applying the anomaly detection module to the plurality of entitlement assignments to determine a corresponding subset of the plurality of anomaly measures, where each respective anomaly measure of the corresponding subset is associated with the respective iteration and a respective entitlement assignment of the plurality of entitlement assignments.

In a nineteenth aspect according to any one of the seventeenth aspect through the eighteenth aspect, determining each respective combined anomaly measure includes combining a corresponding subset of the plurality of anomaly measures, the corresponding subset including anomaly measures determined across the plurality of iterations for the respective entitlement assignment.

In a twentieth aspect, a non-transitory, computer-readable medium is provided that stores instructions which, when executed by a processor, cause the processor to perform operations, including: receiving, by a computing device, a plurality of entitlement assignments associated with a plurality of users from a data repository; repeatedly processing, by the computing device, the plurality of entitlement assignments using an anomaly detection module for a plurality of iterations, to determine a plurality of anomaly measures, where each respective anomaly measure of the plurality of anomaly measures corresponds to a respective iteration of the anomaly detection module and a respective entitlement assignment of the plurality of entitlement assignments; determining, by the computing device, a plurality of combined anomaly measures based on the plurality of anomaly measures, where each respective combined anomaly measure of the plurality of combined anomaly measures corresponds to a respective entitlement assignment of the plurality of entitlement assignments and is determined based on anomaly measures of the plurality of anomaly measures that correspond to the respective entitlement assignment; and determining an entitlement recommendation based on at least a subset of the combined anomaly measures.

The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the disclosed subject matter.

### BRIEF DESCRIPTION OF THE FIGURES

FIG. 1 depicts a system for user entitlement analysis according to one aspect of the present disclosure.

FIG. 2 depicts a relationship diagram for a user according to one aspect of the present disclosure.

FIG. 3 depicts an iterative anomaly analysis scenario according to one aspect of the present disclosure.

FIG. 4 depicts a method for user entitlement analysis according to one aspect of the present disclosure.

FIG. 5 depicts a computer system according to one aspect of the present disclosure.

### DETAILED DESCRIPTION OF EXAMPLE EMBODIMENTS

In large organizations, managing user access to various IT systems, applications, and data sources may be a complex and critical task. Access is often controlled through numerous entitlement groups, roles, and permissions distributed across diverse platforms like Active Directory, specific business applications, cloud environments, and code repositories. This complexity may be further amplified for IT service providers who manage cloud hosting or software as a service (SaaS) functions across multiple client organizations, where maintaining proper entitlement segregation between clients while efficiently administering the overall system presents additional challenges. Ensuring that only the appropriate individuals possess the necessary access rights is crucial for security, compliance, and operational efficiency.

Existing methods for managing and reviewing these entitlements often rely heavily on manual processes. Periodic access reviews typically require managers or system owners to examine lists of users and their assigned entitlements to verify appropriateness. However, given the sheer volume and complexity of entitlements in a large enterprise, these manual reviews may be time-consuming, burdensome, and prone to error. Reviewers may lack sufficient context or understanding of specific entitlements, leading to rubber-stamping or incorrect assessments. Furthermore, identifying users who have accumulated inappropriate access over time (e.g., due to role changes) or determining the correct entitlements for new or transferring employees can be challenging. Simple rule-based systems may lack the nuance to handle complex organizational structures and the subtle patterns that indicate anomalous access. These challenges may create significant cybersecurity risks, increase the likelihood of compliance failures, and hinder user productivity due to delays in obtaining necessary access or confusion over appropriate permissions.

Beyond the challenges of manual review, conventional computational approaches also face significant technical hurdles when analyzing large-scale enterprise entitlement data. This data is often high-dimensional, sparse, and heterogeneous, originating from disparate systems with varying formats and semantics. Representing these complex relationships (e.g., user roles, group memberships across different platforms, organizational hierarchies, resource characteristics) in a way that is amenable to effective computational analysis may be difficult. Standard database queries or simple rule-based engines may struggle to capture the nuanced, context-dependent patterns that distinguish appropriate access from potentially risky outliers, especially when dealing with subtle deviations or novel scenarios not covered by predefined rules.

Furthermore, applying standard anomaly detection algorithms directly to this type of data may yield unreliable or inefficient results. Many algorithms may be computationally expensive when faced with the sheer scale and dimensionality involved. More critically, certain powerful techniques, such as those based on random partitioning like Isolation Forest, exhibit inherent stochasticity. A single run of such an algorithm on complex entitlement data might produce inconsistent results, flagging different sets of entitlements as outliers depending on the internal random choices made during execution. This computational instability makes it difficult to rely on a single pass for consistent and accurate identification of genuine anomalies, presenting a technical problem in leveraging these algorithms effectively for dependable entitlement analysis within computing systems.

One solution to this problem is to employ automated techniques for analyzing entitlement appropriateness using iterative anomaly detection. The described techniques may involve receiving a plurality of entitlement assignments and associated user profile data. A computing device may then repeatedly process this data using an anomaly detection module, such as one employing an Isolation Forest model, for a set number of iterations. In each iteration, the module may generate anomaly measures indicating the potential anomalousness of each entitlement assignment relative to others, potentially considering user features like role, team, manager, or even other entitlements.

A key aspect of these techniques may be the aggregation of anomaly measures across the multiple iterations. By combining the results from numerous runs (e.g., by summing scores, averaging scores, or counting how often an assignment was flagged), a combined anomaly measure may be determined for each entitlement assignment. This iterative processing and aggregation approach may help mitigate the impact of randomness inherent in some anomaly detection algorithms and reduce the likelihood of identifying spurious outliers that appear inconsistently across runs, thus providing a more robust assessment. Based on these combined measures, the system may generate entitlement recommendations, such as identifying high-confidence outliers for review, calculating confidence scores for appropriateness, suggesting potentially missing entitlements by analyzing consistently normal assignments (inliers) among peer groups, or even triggering automated alerts, enhanced monitoring, or remediation actions. This automated, data-driven analysis may augment or streamline manual review processes.

In some aspects, the present disclosure provides techniques for robust user entitlement analysis using iterative anomaly detection that may be particularly beneficial in complex enterprise IT environments. For example, compared to traditional manual review processes, the described techniques may offer a more automated, scalable, and potentially more accurate way to identify potentially inappropriate or anomalous entitlement assignments. By repeatedly processing entitlement data through an anomaly detection module and aggregating the results, the techniques may reduce the impact of spurious outliers that might arise from a single analysis run, leading to more reliable identification of assignments warranting review. This may improve the efficiency and effectiveness of periodic access reviews and entitlement management, potentially reducing the burden on human reviewers and mitigating risks associated with incorrect or excessive permissions.

Furthermore, these techniques may improve the experience for end users and managers. By analyzing entitlement patterns and identifying inliers within peer groups, the system may suggest appropriate entitlements for new or transferring employees, potentially speeding up the onboarding process and ensuring users get the access they need more quickly. Identifying outliers may also help proactively address access creep before it becomes a significant security issue. The techniques may be particularly valuable for IT service providers who can offer the entitlement advisor as a service to their clients while also using it internally to manage entitlements across their entire multi-tenant environment, ensuring proper segregation between client organizations while optimizing their administrative operations. From a computing perspective, the techniques involving iterative processing and aggregation, especially when potentially combined with feature weighting or tailored configurations (like adjusting iteration counts or contamination parameters), represent a specific technical approach to applying machine learning for anomaly detection in the domain of entitlement management. The generation of combined anomaly measures and subsequent actions (alerts, enhanced monitoring, step-up authentication, automated remediation) may improve the functioning of the computer system itself by enabling more targeted security controls and automated responses based on a data-driven assessment of entitlement risk, thereby enhancing the overall security posture and operational efficiency of the organization's IT systems.

The iterative processing and aggregation techniques described herein may offer specific technical improvements to the functioning of the computer system performing the analysis. By executing the anomaly detection module multiple times and combining the resulting measures, the system can technically overcome the inherent computational instability or randomness associated with certain underlying algorithms when applied to complex datasets like entitlement assignments. This results in a more stable, reliable, and accurate computational output (the combined anomaly measures), reducing the generation of spurious outliers that might otherwise trigger unnecessary downstream actions or alerts. This improved reliability of the computational result is a technical benefit directly addressing a limitation in applying such algorithms singularly.

Moreover, the generation of a robust combined anomaly measure provides a technically refined input signal for integrated downstream systems. When triggering actions like enhanced monitoring, step-up authentication, or automated remediation, the reliability of the triggering signal is crucial for the proper functioning of those security systems. Using a combined measure derived from multiple analyses enhances the confidence in the signal, potentially leading to more accurate automated security responses and reducing false positives compared to systems relying on single-pass analysis results. Additionally, the ability to analyze different feature subsets (e.g., organizational vs. peer group features) separately and then combine the results represents a specific computational strategy for dissecting complex dependencies within the data, potentially leading to more nuanced and accurate recommendations compared to monolithic analysis approaches, thereby improving the computer's ability to model and reason about entitlement appropriateness.

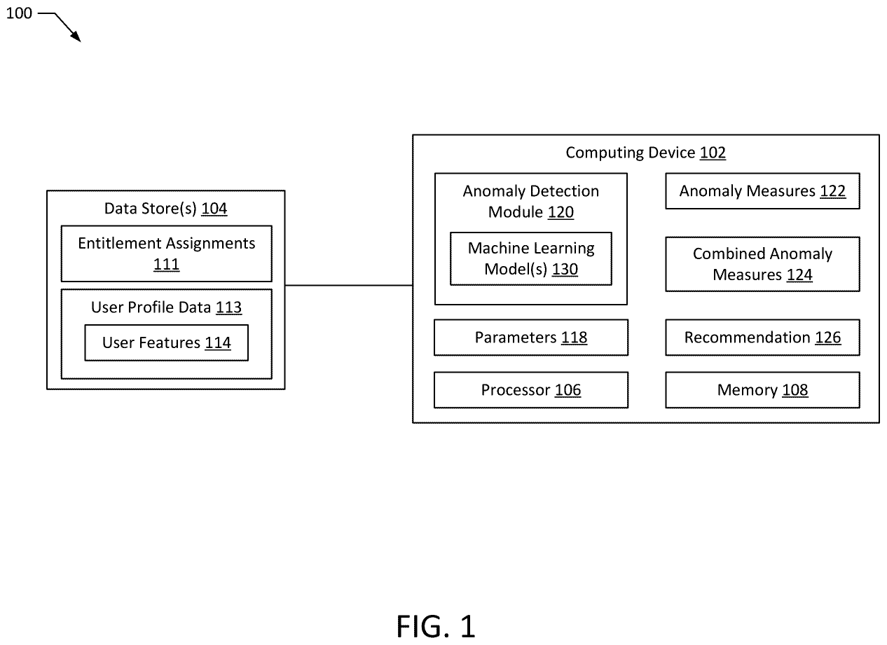

FIG. 1 depicts a system 100 for user entitlement analysis according to one aspect of the present disclosure. The system 100 includes a computing device 102 and a data store 104. The data store includes entitlement assignments 111 and user profile data 113, which includes user features 114. The computing device 102 includes a processor 106, a memory 108, and an anomaly detection module 120 containing one or more machine learning models 130. The computing device 102 further includes configuration parameters 118, anomaly measures 122, combined anomaly measures 124, and an entitlement recommendation 126.

The computing device 102 may be configured to receive a plurality of entitlement assignments 111 associated with a plurality of users from a data repository 104. Entitlement assignments 111 may refer to the specific access rights or permissions granted to users within an organization's information technology environment. These assignments may dictate what resources a user can access and what actions they can perform. In certain implementations, the plurality of entitlement assignments 111 may include a wide variety of permission types across diverse systems. For example, entitlement assignments 111 may include Active Directory group memberships, application-specific roles (e.g., roles within financial reporting software or customer relationship management platforms), database access privileges (e.g., read/write permissions on specific tables or schemas), system login rights for various operating systems or platforms (e.g., mainframe systems like IBM iSeries®, Linux/Unix servers, cloud infrastructure platforms like AWS® or Azure®), file and folder permissions on network shares or collaboration platforms, access control for code repositories such as GitHub® or GitLab® (e.g., commit rights to specific branches), permissions within Continuous Integration/Continuous Deployment (CI/CD) tools like Jenkins® (e.g., rights to trigger builds or deploy applications), API keys granting access to specific services, software tool licenses, and granular data access permissions controlling visibility into specific datasets or reports. These entitlement assignments 111 may be represented in various ways within enterprise systems, such as entries in access control lists (ACLs), membership records in group directories, attribute flags on user objects, or records within application-specific authorization tables stored in the data repository 104.

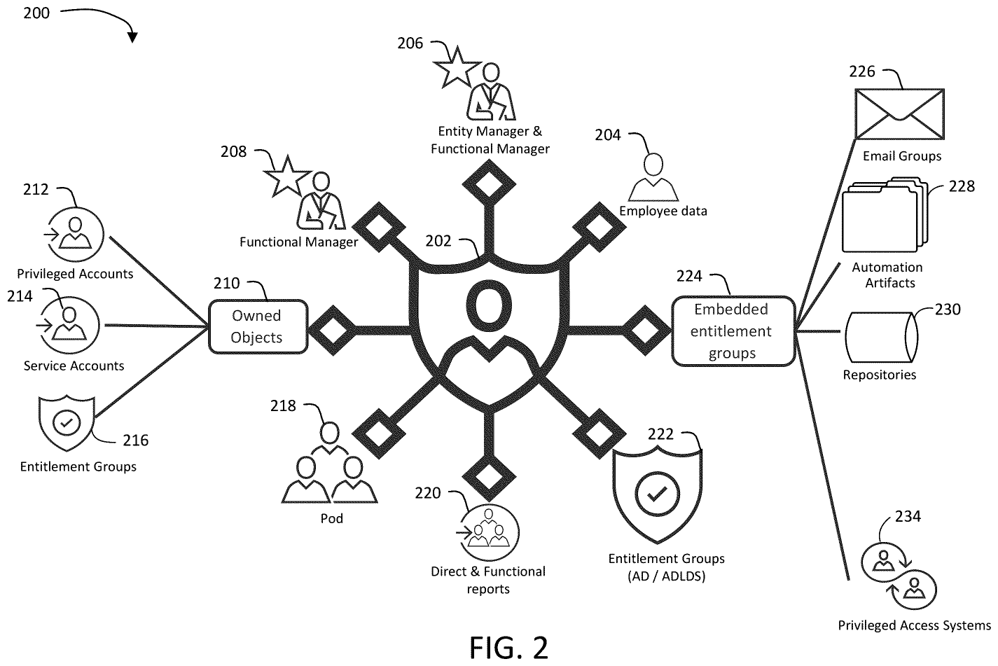

As one example, FIG. 2 depicts a relationship diagram 200 for a user 202 according to one aspect of the present disclosure. This diagram 200 illustrates the variety of data points and relationships that may collectively define or otherwise be associated with the user 202 within an organizational context. Each of these relationships may be associated with a particular entitlement assignment 111 associated with the user 202. The user 202 may be associated with core employee data 204, potentially including HR information like role, department, and location. Organizational relationships may also be associated with the user 202, such as reporting lines to an entity manager and/or functional manager 206, a separate functional manager 208, direct and functional reports 220 who report to the user 202, and membership within a specific team or pod 218.

Furthermore, the user 202 may be associated with various types of entitlements and related objects. The user 202 may be a member of directory-based entitlement groups 222, such as those managed in Active Directory (AD) or Active Directory Lightweight Directory Services (ADLDS). Additionally, the user 202 may belong to embedded entitlement groups 224, which represent access rights managed within specific applications or platforms. Examples of systems containing such embedded groups 224 may include email distribution groups 226, permissions structures within automation server artifacts or folders 228, access controls within code repository organizations or specific repositories 230, permissions within various other systems, and roles defined within privileged access management systems 234. Beyond direct membership, the user 202 might also be associated with owned objects 210, potentially including responsibility for privileged accounts 212, service accounts 214, or specific entitlement groups 216 that the user 202 manages or administers. Collectively, these different data points and relationships illustrated in diagram 200 contribute to the complex profile of a user 202 and represent potential inputs or contextual factors for analyzing the appropriateness of their entitlement assignments 111.

Returning to FIG. 1, the plurality of users may encompass the workforce of a large organization, potentially scaling from hundreds to thousands or even hundreds of thousands of individuals requiring access to enterprise resources. Each user within this plurality may be uniquely identified, for instance, by an employee ID, a network login name, or another unique identifier maintained within the organization's identity management systems. The entitlement assignments 111 are associated with these users, meaning a link or relationship exists connecting a specific user identity to a specific grant of access. This association may be stored and represented within the data repository 104 through various mechanisms. For example, an entitlement group may maintain a list of member user IDs, a user's profile object in a directory may list the groups they belong to or roles they possess, or an access control list on a resource may explicitly enumerate the users or groups permitted access.

The data repository 104, from which the entitlement assignments 111 are received, may represent one or more sources of entitlement and user information within the enterprise. In certain implementations, the data repository 104 may be a centralized data store, such as an enterprise data lake or data warehouse, designed to aggregate information from multiple sources. Alternatively, the data repository 104 may represent a collection of distributed databases or specific authoritative source systems. For instance, the computing device 102 might receive data directly from systems like Microsoft Active Directory, Human Resources (HR) databases (e.g., Workday®, SAP SuccessFactors®), Identity and Access Management (IAM) platforms (e.g., Okta®, Ping Identity®), or application-specific user management tables. These repositories 104 often contain large volumes of data in heterogeneous formats, reflecting the complexity and diversity of systems within a large organization. The received data may constitute the stored entitlement assignments 111 within the data store 104 accessible by the computing device 102.

The computing device 102 may be implemented in various ways suitable for processing potentially large-scale entitlement data. For instance, the computing device 102 may be a single high-performance server, a cluster of interconnected servers operating in parallel, or resources provisioned within a cloud computing environment. In certain implementations, the computing device 102 may employ a distributed system architecture to handle the computational load. Regardless of the specific hardware configuration, the computing device 102 typically includes one or more processors 106 and associated memory 108 sufficient to execute the necessary data processing and machine learning tasks.

The computing device 102 may be configured to receive the plurality of entitlement assignments 111 through various mechanisms. For example, the computing device 102 may be configured to execute scheduled batch jobs that periodically extract data from the source systems or data repository 104. Alternatively, the computing device 102 may use Application Programming Interface (API) calls to query source systems for entitlement information in near real-time or may perform direct database queries against the data repository 104. In some implementations, streaming data feeds may push updates regarding entitlement changes to the computing device 102. This receiving process may involve data ingestion pipelines that handle data extraction, potential transformations (e.g., standardizing data formats, resolving different naming conventions), and loading the data into a format suitable for analysis, such as populating the entitlement assignments 111 in the data store 104.

In certain implementations, the computing device 102 may perform preprocessing steps upon receiving the data to address potential data quality issues. Enterprise entitlement data can sometimes be incomplete, inconsistent, or contain errors. Preprocessing steps performed by the processor 106 might include handling missing values (e.g., imputing missing user attributes based on related data), normalizing data formats (e.g., standardizing date formats or location names), resolving inconsistencies between different data sources (e.g., reconciling conflicting group membership information), and potentially filtering out irrelevant or known erroneous data before storing it as the stored entitlement assignments 111.

The scale of the data received and processed by the computing device 102 can be substantial, particularly in large organizations. This may involve data pertaining to tens or hundreds of thousands of users, thousands or tens of thousands of distinct entitlement groups or roles, resulting in potentially millions or tens of millions of individual user-entitlement assignment records 111 that need to be received, stored, and analyzed.

The computing device 102 may also be configured to repeatedly process the plurality of entitlement assignments 111 using an anomaly detection module 120 for a plurality of iterations, to determine a plurality of anomaly measures 122. The anomaly detection module 120 may be understood as a functional component, potentially implemented in software executing on the processor 106 using memory 108, responsible for identifying unusual or unexpected patterns within the entitlement data. This module 120 typically encapsulates one or more data analysis algorithms designed for outlier or anomaly detection.

The processing may be performed over a plurality of iterations, in which an anomaly detection process performed by the module 120 may be executed multiple times. In certain implementations, the process may be repeated N times, where N is an integer greater than one (N>1), using the same input data, such as the received plurality of entitlement assignments 111 or a relevant subset thereof defined for a specific analysis context (e.g., members of a particular group). In certain implementations, N may be at least 2, at least 3, at least 5, at least 10, at least 50, at least 100, and the like. This iterative execution may be used to enhance the robustness and reliability of the anomaly detection. By running the analysis multiple times, the system 100 can mitigate the impact of randomness inherent in some algorithms (like Isolation Forest's random partitioning) or sensitivity to initial conditions, thereby helping to filter out spurious outliers (such as assignments flagged inconsistently across iterations) from those that are consistently identified as anomalous. The number of iterations, N, may be stored as one of the configuration parameters 118.

Each execution of the anomaly detection module 120 during one iteration may determine a set of anomaly measures 122. In particular, an anomaly measure 122 may quantify the degree of deviation from normalcy for a specific entitlement assignment 111 within the context of the data processed during that particular iteration. Additionally or alternatively, an anomaly measure may quantify a predicted likelihood that a particular entitlement assignment 111 is likely to be an anomaly or outlier, according to a particular iteration. Particular implementations of the anomaly measure 122 may vary depending on the specific techniques employed within the anomaly detection module 120. For instance, an anomaly measure 122 may be implemented as a continuous score, such as a value between −1 and +1 where negative scores indicate higher anomaly likelihood. Such implementations may be used when the anomaly detection module 120 utilizes an isolation forest model. Alternatively, the anomaly 122 could be a probability score indicating the likelihood of being an anomaly, or a simple binary flag (e.g., 1 for anomaly, 0 for normal). Each respective anomaly measure 122 corresponds to both the specific iteration during which it was generated and the specific entitlement assignment 111 it evaluates. For example, if ‘M_ij’ represents the anomaly measure for the ‘j’-th entitlement assignment during the ‘i’-th iteration, the repeated processing generates a collection of such measures across all N iterations and all relevant entitlement assignments. A conceptual table could illustrate this, showing rows for different entitlement assignments and columns for iterations 1 through N, with each cell containing the corresponding anomaly measure ‘M_ij’.

The input provided to the anomaly detection module 120 for each iteration typically uses the context derived from the received plurality of entitlement assignments 111. For example, when analyzing the appropriateness of User A's membership in Group X (one specific entitlement assignment), the module 120 might consider the characteristics (e.g., other group memberships, user profile features) of all members of Group X, or compare User A's overall entitlement profile against other similar users, using the broader set of received entitlement assignments 111 and potentially user profile data 113 as the basis for comparison and pattern identification. The process determines individual anomaly measures 122 for specific assignments 111 within the context established by the larger set of assignments being processed.

In certain implementations, repeatedly processing the plurality of entitlement assignments 111 for the plurality of iterations includes, for each respective iteration of the plurality of iterations, applying the anomaly detection module 120 to the plurality of entitlement assignments 111 (or the relevant analytical subset) to determine a corresponding subset of the plurality of anomaly measures 122. Applying the anomaly detection module 120 may involve initializing or executing one or more underlying process(es). For processes involving randomness, like isolation forest, applying the module 120 in each iteration may involve using a different random seed or ensuring that random choices made within the algorithm (e.g., feature selection and split points in trees) differ across iterations, thereby generating potentially different perspectives on the data's structure in each run. The corresponding subset of the plurality of anomaly measures 122 may refer to the complete set of anomaly measures generated during a single, specific iteration.

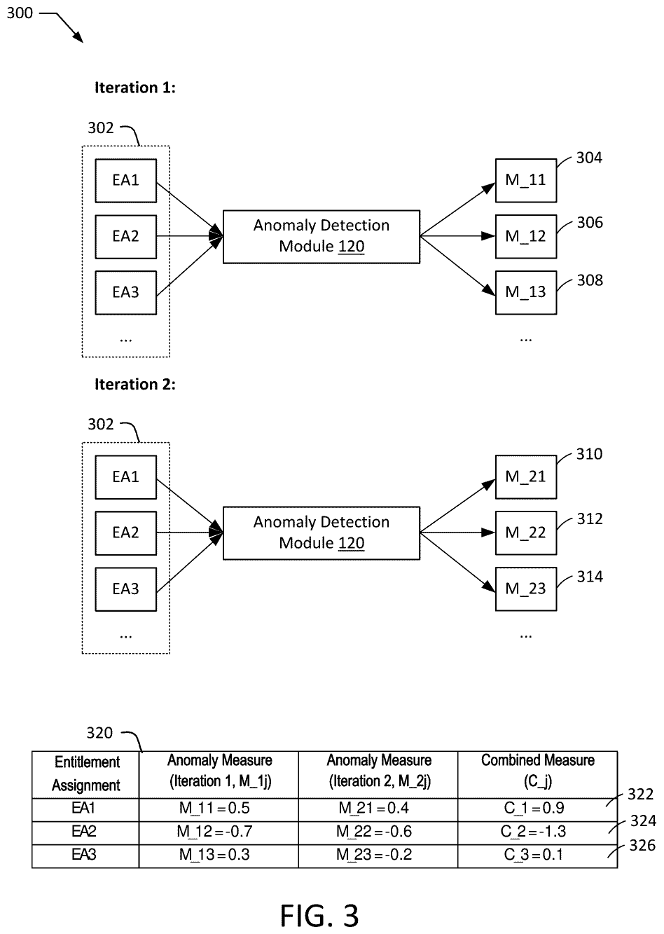

As a specific example, FIG. 3 depicts an iterative anomaly analysis scenario 300 according to one aspect of the present disclosure. The scenario 300 illustrates the first two iterations of an analysis of a set of input entitlement assignments 302 (labeled EA1, EA2, EA3), which may include two or more total iterations. In the first iteration, the input 302 is processed by the anomaly detection module 120 to produce a first subset of anomaly measures 304, 306, 308, labeled as M_11, M_12, and M_13, corresponding to assignments EA1, EA2, and EA3 respectively. Similarly, in the second iteration, the same input 302 is processed again by the anomaly detection module 120 (potentially with different internal randomness) to produce a second subset of anomaly measures 310, 312, 314, labeled as M_21, M_22, and M_23. Generally, for iteration ‘i’ and entitlement assignment ‘j’, the resulting measure is denoted M_ij.

In certain implementations, the anomaly detection module 120 may include one or more machine learning models 130. Machine learning models 130 serve as the core algorithmic engine within the module 120 for identifying patterns and deviations. Applying the anomaly detection module 120 during each iteration may then include providing the relevant plurality of entitlement assignments 111 as input to these one or more machine learning models 130. In certain implementations, at least a portion of the user features 114 may be provided to the anomaly detection module 120 as well. The entitlement assignments 111 and user features 114 may need to be formatted for consumption by the models 130. For example, data may be transformed into numerical feature vectors, where categorical features (like department names or entitlement group names) are encoded using techniques like one-hot encoding or transformed into embedding vectors. If graph-based analysis is used, the input might be represented as adjacency matrices or node/edge feature lists.

In certain implementations, the one or more machine learning models 130 may include an unsupervised anomaly detection model. Unsupervised models may be advantageous because such models do not require pre-labeled training data indicating which entitlements are anomalous or inappropriate, as such labels are often unavailable or subjective in complex enterprise environments. In certain implementations, the unsupervised anomaly detection model may be an Isolation Forest model 130. Isolation forest models operate by building an ensemble of isolation trees (iTrees). For each tree, data points are recursively partitioned by randomly selecting a feature and then randomly selecting a split value for that feature between the minimum and maximum values present in the data subset. Anomalous points, being few and different, tend to be isolated closer to the root of the trees (requiring fewer partitions), resulting in shorter average path lengths across the ensemble of trees. The anomaly score for a data point is derived from this average path length, typically normalized to a score between −1 and +1, where scores closer to −1 indicate higher anomaly likelihood. Advantages of Isolation Forest for entitlement analysis include its general efficiency on large datasets, its ability to handle high-dimensional feature spaces (common when using many user features or other entitlements as features), and the fact that it does not assume a specific distribution (e.g., Gaussian) for the data.

In addition to the isolation forest model discussed above, additional or alternative unsupervised models may include Local Outlier Factor (LOF) models, configured to assess anomaly based on local density deviation compared to neighbors; One-Class Support Vector Machines (SVM) configured to find a boundary around the normal data points; autoencoders trained to reconstruct normal data well but fail on anomalous data; or clustering-based methods like DBSCAN, where points not assigned to any cluster may be considered anomalies. For instance, LOF calculates a score based on how isolated a point is relative to its surrounding neighborhood density, making it effective at finding anomalies in areas of varying density. Autoencoders learn a compressed representation of the input data and anomalies often result in higher reconstruction errors when passed through the trained model.

In certain implementations, applying the anomaly detection module 120 for the plurality of iterations may include performing multiple iterations, such as a first iteration, a second iteration, and the like. In such instances, the first iteration may involve applying the anomaly detection module 120 to the plurality of entitlement assignments 111 to determine a first subset of the plurality of anomaly measures 122. Each anomaly measure in this first subset may correspond to the first iteration and a respective entitlement assignment 111 being analyzed. Subsequently, a second iteration may involve applying the anomaly detection module 120 again to the same plurality of entitlement assignments 111 (potentially with different internal randomness) to determine a second subset of the plurality of anomaly measures 122. Each measure in this second subset may correspond to the second iteration and a respective entitlement assignment 111. This process may repeat (such as for all N iterations).

As a specific example, and returning to FIG. 3, the anomaly detection module 120 maybe assumed to output scores between −1 and 1. The results for the first iteration are shown as M_11=0.5 (anomaly measure 304 for EA1), M_12=−0.7 (anomaly measure 306 for EA2) in the table 320, and M_13=0.3 (anomaly measure 308 for EA3). The results for the second iteration, potentially differing due to algorithmic randomness, are shown as M_21=0.4 (anomaly measure 310 for EA1), M_22=−0.6 (anomaly measure 312 for EA2), and M_23=−0.2 (anomaly measure 314 for EA3) in the table 320. Thus, each iteration may generates a distinct set of anomaly measures, and these measures may vary across iterations (such as EA2, having measures 306 and 312) can vary across iterations.

In certain implementations, the method may further include receiving, by the computing device 102, user profile data 113 associated with the plurality of users from the data repository 104. This user profile data 113 may contain a plurality of user features 114, providing contextual information about the users associated with the entitlement assignments 111. The plurality of user features 114 may serve as crucial input context for the anomaly detection module 120, helping the module 130 understand what constitutes normal or baseline entitlement patterns for users with specific characteristics. The receiving of user profile data 113 may occur concurrently with or separately from receiving the entitlement assignments 111, potentially from the same or different parts of the data repository 104 (e.g., HR system vs. directory service). The data may be joined or correlated by the computing device 102 during processing. In such implementations, the anomaly detection module 120 may be configured to process both the plurality of entitlement assignments 111 and the plurality of user features 114 together to determine the plurality of anomaly measures 122. For example, when analyzing User A's membership in Group X, the input to the model 130 might be a feature vector representing User A, including their department, role, manager (from user features 114), and potentially their membership status in other groups (derived from entitlement assignments 111).

In certain implementations, the plurality of user features 114 may include one or more specific types of attributes. For instance, a user role may refer to the user's official job title (e.g., Senior Accountant) or a functional designation within the organization (e.g., Database Administrator, Sales Representative, Compliance Officer). User team membership may identify the specific organizational unit (e.g., Marketing Department, Infrastructure Operations Team) or project team (e.g., Project Phoenix, Q2 Product Launch Team) the user belongs to, and may be represented by names or IDs. Furthermore, user manager identity may include the unique identifier (e.g., employee ID or username) of the user's direct reporting manager, and potentially a functional or matrix manager if applicable in the organization's structure; distinguishing manager types can be important as functional managers might be more relevant for certain types of entitlements. User business unit affiliation may specify the larger division, cost center, or line of business the user is part of (e.g., Retail Banking Division, Corporate IT, EMEA Sales). Additionally, user location might indicate the physical office building, city, or country where the user is primarily based, which can be relevant for region-specific access rights. These features 114 are often categorical and may be encoded numerically for use by machine learning models 130, for instance, using one-hot encoding (creating binary columns for each category) or by learning dense vector representations (embeddings).

In certain implementations, the plurality of user features 114 used in the analysis may specifically include other entitlement assignments 111 associated with the plurality of users. In such instances, when evaluating the anomalousness of User A's membership in Entitlement X, the model 130 may consider which other entitlements (e.g., Entitlement Y, Entitlement Z) User A also possesses. A feature vector might be constructed for User A (or specifically for the User A/Entitlement X combination being analyzed) where each dimension corresponds to another potential entitlement in the organization, and the value indicates membership (e.g., 1 if member, 0 if not).

In certain implementations, the computing device 102 may be further configured to determine feature weights for different user features 114 and apply these weights during the processing by the anomaly detection module 120. Feature weights allow the system 100 to assign different levels of importance to various user attributes when assessing entitlement appropriateness. For example, a user's department might be considered more influential than their physical location for determining the normalcy of access to a departmental application. These weights might be determined based on predefined business rules or expert knowledge provided by security analysts or compliance officers. Alternatively, weights could be learned through preliminary data analysis or assigned based on factors like data quality or observed predictive power of the feature. The application of these weights can occur in several ways. Feature values might be multiplied by their corresponding weights before being fed into the machine learning model 130. Some algorithms might inherently support feature weighting as part of their process. Alternatively, weights could be applied in a post-processing step to the outputs associated with different features before the final aggregation of anomaly measures 122.

In certain implementations, the computing device 102 may further configured to determine values for configuration parameters 118 associated with the anomaly detection module 120 prior to commencing the repeated processing. These configuration parameters 118 may control the behavior of the anomaly detection algorithms. In implementations where the machine learning model 130 is an isolation forest model, the configuration parameters 118 may include an expected contamination parameter. The contamination parameter in Isolation Forest provides an estimate of the proportion of outliers expected in the dataset. It influences the threshold used internally by the algorithm to classify points as anomalies based on their path lengths/scores. While the multi-run and aggregation approach of the present system reduces reliance on this parameter to avoid flagging a fixed percentage, setting an initial reasonable value (e.g., a small default like 0.01, 0.02, or 0.05, representing 1%, 2%, or 5% expected outliers) can help calibrate the sensitivity of the individual runs. The value might be adjusted based on the size of the group being analyzed or prior knowledge about the expected prevalence of outliers in specific contexts. In additional or alternative implementations, the parameters 118 may include one or more of a number of trees to build in an Isolation Forest, a type of kernel function to use in an SVM, a neighborhood size (k) in LOF, or a specific architecture (number of layers, nodes per layer) for a neural network like an autoencoder, and the like.

In certain implementations, the computing device 102 may be configured to determine a plurality of combined anomaly measures 124 based on the plurality of anomaly measures 122 generated across the iterations. A combined anomaly measure 124 may refer to a single, aggregated metric calculated for each respective entitlement assignment 111. Its purpose is to provide a more robust and stable indicator of the anomalousness associated with that entitlement assignment, derived from the multiple perspectives or results obtained across the plurality of iterations performed by the anomaly detection module 120. Each respective combined anomaly measure 124 corresponds to a specific entitlement assignment 111 being analyzed.

In certain implementations, determining each respective combined anomaly measure 124 includes combining a corresponding subset of the plurality of anomaly measures 122. This corresponding subset may specifically refer to the collection of all N anomaly measures 122 associated with a single, particular entitlement assignment 111, gathered from each of the N iterations; for entitlement assignment ‘j’, this subset is {M_1j, M_2j, . . . , M_Nj}. This contrasts with the subsets generated during each iteration (which contained measures for _all_ assignments from _one_iteration). The act of combining this subset may include applying a mathematical or logical operation to the N measures within the subset to yield the single combined anomaly measure 124 for that entitlement assignment. Various aggregation functions may be employed for this combination.

As a particular example, and returning to FIG. 3, Table 320 illustrates the grouping of the individual measures for aggregation. For the first entitlement assignment (EA1), the corresponding subset used for aggregation consists of the measures from each iteration, namely {M_11 (anomaly measure 304), M_21 (anomaly measure 310)}. Similarly, for EA2, the subset is {M_12 (anomaly measure 306), M_22 (anomaly measure 312)}, and for EA3, the subset is {M_13 (anomaly measure 308), M_23 (anomaly measure 314)}. Combining this subset (e.g., using summation as shown in Table 320) results in the combined measure C_j for the ‘j’-th entitlement assignment (e.g., C1 (combined anomaly measure 322), C2 (combined anomaly measure 324), C3 (combined anomaly measure 326)). This combined measure C_j is determined based on the set of individual anomaly measures 122 generated for that specific entitlement assignment ‘j’ across all N iterations.

In certain implementations, combining the corresponding subset of the plurality of anomaly measures 122 includes determining a sum of the anomaly measures 122 in that subset. This summation process involves adding together the N individual anomaly measures associated with a specific entitlement assignment. If the individual measures are scores like those from Isolation Forest 130 (where negative values indicate anomalies), a large negative sum for a combined anomaly measure 124 would suggest that the entitlement assignment was consistently identified as anomalous across many iterations, indicating a potentially genuine outlier. Conversely, a sum close to zero or positive might indicate the assignment was rarely or never flagged as anomalous.

In certain implementations, combining the corresponding subset of the plurality of anomaly measures 122 includes determining an average of the anomaly measures 122 in that subset. This averaging process involves summing the N individual anomaly measures for an assignment and dividing by N. The resulting average provides a normalized score, representing the typical anomaly level identified for that assignment across the iterations. Similar to summation, a strongly negative average score might indicate a consistent outlier, while an average score near zero or positive suggests normalcy. Averaging can be useful for comparing combined measures across analyses that might have used different numbers of iterations.

In certain implementations, the combination may involve counting. In this approach, each individual anomaly measure 122 from an iteration is first potentially converted into an indicator, signifying whether the respective entitlement assignment 111 was identified as anomalous in that specific iteration. This conversion might involve applying a threshold to the raw anomaly measure; for example, if an anomaly score M_ij is less than a predefined threshold (e.g., score<0), the indicator might be set to 1 (anomalous), otherwise 0 (normal). Combining the corresponding subset for an entitlement assignment then includes determining a count of these indicators across the N iterations. This is achieved by summing the binary indicators (0s and 1s) for that assignment over the N iterations. The resulting combined anomaly measure 124 is an integer count (from 0 to N) representing how many times the assignment was flagged as anomalous. For example, a count of 8 out of N=10 iterations indicates the assignment was deemed anomalous in 80% of the runs, providing a clear frequency-based interpretation of outlier consistency.

In certain implementations, after determining the raw combined anomaly measures 124 using methods like summation, averaging, or counting, the computing device 102 may apply further normalization or scaling transformations. For example, scores might be scaled to a specific range (e.g., 0 to 100) or converted into percentiles relative to all other combined measures determined in the analysis. Such transformations can aid in interpretability and in setting consistent thresholds for downstream actions or reporting.

In certain implementations, the determination of the plurality of combined anomaly measures 124 may involve determining a first combined anomaly measure and a second combined anomaly measure for different entitlement assignments. As an example, and returning to FIG. 3, the scenario shows N=2 iterations for assignments EA1, EA2, and EA3. A first combined anomaly measure 322 (C1) for the first entitlement assignment (EA1) is determined based on its corresponding subset {M_11 (anomaly measure 304)=0.5, M_21 (anomaly measure 310)=0.4}. A second combined anomaly measure C2 (324) for the second entitlement assignment (EA2) is determined based on its corresponding subset {M_12 (anomaly measure 306)=−0.7, M_22 (anomaly measure 312)=−0.6}. This process is repeated for all entitlement assignments; for EA3, the combined measure 326 (C3) is determined from subset {M_13 (anomaly measure 308)=0.3, M_23 (anomaly measure 314)=−0.2}. In the specific example illustrated in Table 320, the measures are combined using summation. Therefore, the resulting combined anomaly measures are C1 (combined anomaly measure 322)=0.5+0.4=0.9, C2 (combined anomaly measure 324)=(−0.7)+(−0.6)=−1.3, and C3 (combined anomaly measure 326)=0.3+(−0.2)=0.1

In certain implementations, analysis by the module 120 may be performed separately based on different subsets of user features 114. The computing device 102 may determine a first subset of the plurality of user features 114 (e.g., organizational features like manager, department, role) and a second subset (e.g., peer group features like other entitlement memberships). The entire repeated processing (N iterations) using the anomaly detection module 120 may then performed for the first subset to determine a first set of combined anomaly measures 124. Similarly, the repeated processing may thus performed using the second subset to determine a second set of combined anomaly measures 124. This separation allows for isolating the influence of different contextual factors. The final entitlement recommendation 126 may then be determined based on combining the first set and the second set of combined anomaly measures 124.

In certain implementations, the computing device 102 may be configured to determine an entitlement recommendation 126 based on at least a subset of the combined anomaly measures 124. The entitlement recommendation 126 may refer to the output generated by the system 100, designed to provide actionable insight regarding the appropriateness, risk, or potential need associated with specific entitlement assignments 111. This recommendation 126 may be derived directly from the analysis of the combined anomaly measures 124 calculated in the preceding step. For instance, the determination may be based on at least a subset of the combined anomaly measures 124 such that the computing device 102 considers all calculated combined measures, or focuses on a specific portion, such as only those measures that exceed a certain anomaly threshold, the top K most anomalous assignments identified, or those falling within a specific range indicating normalcy (such as for inlier analysis).

In certain implementations, determining the entitlement recommendation 126 includes determining a confidence score for one or more entitlement assignments 111 based on the combined anomaly measures 124. A confidence score provides a quantitative measure of the system's certainty regarding the status (e.g., appropriateness or inappropriateness) of an entitlement assignment. This score may be determined by transforming or mapping the calculated combined anomaly measure 124 onto a more interpretable scale. For example, if the combined anomaly measure 124 is a score where more negative values indicate higher anomaly, this score could be mapped to a percentage representing the confidence that the assignment is inappropriate (e.g., a combined score of −1.3 might translate to an 85% confidence of being inappropriate). Alternatively, if the combined measure 124 is a count of how many times an assignment was flagged as anomalous (e.g., 8 out of 10 iterations), the confidence score might be directly derived as a percentage (e.g., 80% confidence).

In certain implementations, determining the entitlement recommendation 126 includes identifying one or more entitlement assignments 111 as potentially inappropriate based on the combined anomaly measures 124 exceeding a predetermined threshold. This may involve comparing each calculated combined anomaly measure 124 against a defined threshold value. The predetermined threshold may be set based on various factors, such as the organization's risk tolerance, empirical results from validation experiments, or statistical properties of the combined anomaly measures (e.g., setting the threshold at the 95th percentile of anomalous scores). The nature of the threshold depends on the type of combined anomaly measure 124 being used; for instance, a threshold for a sum or average score might be a negative value (e.g., score<−1.0), whereas a threshold for an anomaly count might be an integer (e.g., count>3 out of 10). The identification occurs when a specific combined anomaly measure 124 associated with an entitlement assignment 111 meets the condition set by the threshold (e.g., is less than the score threshold or greater than the count threshold).

In certain implementations, determining the entitlement recommendation 126 includes identifying one or more users associated with potentially inappropriate entitlement assignments 111 based on the combined anomaly measures 124. Once an entitlement assignment 111 is identified as potentially inappropriate (e.g., by exceeding the threshold), the computing device 102 may use the initial association data received from the data repository 104 to link that specific assignment back to the individual user or users who currently possess it. The recommendation 126 may then explicitly name the user(s) whose access warrants review.

In certain implementations, the computing device 102 may be configured to determine, based on the combined anomaly measures 124, one or more inlier entitlement assignments. Inlier entitlement assignments refer to those assignments identified as consistently non-anomalous or normal across the plurality of iterations. Inlier entitlement assignments may be identified by examining the combined anomaly measures 124 and selecting those that fall below an anomaly threshold or within a range deemed ‘normal’ (e.g., scores close to zero or positive, or low anomaly counts). The computing device 102 may then determine a suggestion for a missing entitlement for a target user based on comparing the entitlement assignments 111 of the target user to the entitlements held by peer users who possess these inlier assignments. Peer users may be identified based on similarity in user profile features 114 (e.g., users in the same department and role, or reporting to the same manager). The comparing process may involve identifying entitlements that are commonly held by the identified peer group (especially those identified as inliers for that group) but are currently missing from the target user's profile (who might be, for example, a new hire or someone recently transferred into that peer group). Based on this comparison, the computing device 102 may determine a suggestion, which may be presented as part of the entitlement recommendation 126. For example: “Users similar to Target User often have Entitlement Z; consider granting this access.”

The resulting entitlement recommendation 126 may be formatted, stored, or otherwise output in various ways. For instance, the recommendation 126 may be structured data stored in memory 108 or persisted in the data store 104, such as records in a database table or a JSON object. The recommendation 126 may additionally or alternatively be rendered as a human-readable report or displayed on a dashboard interface. The content included within the recommendation 126 may include the identified entitlement assignments (whether outliers or suggested inliers), associated users, the corresponding combined anomaly measure or confidence score, and potentially contextual information or reasoning.

In certain implementations, the computing device 102 may be further configured to generate an alert notification based on the entitlement recommendation 126. Such alerts serve to proactively inform relevant parties about potentially risky or noteworthy findings. Alert notifications may take various forms, including emails sent to managers or security administrators, SMS messages for urgent issues, updates to monitoring dashboards, entries in system logs, or automatically generated tickets in an IT Service Management (ITSM) system. The content of the alert may specify the user, the entitlement assignment 111 in question, the associated combined anomaly measure 124 or confidence score, potentially a brief reason or summary, and perhaps a recommended action (e.g., Review Urgently). Trigger conditions for alerts may be configurable, such as generating an alert only when a confidence score exceeds a critical threshold or when a high-risk entitlement is flagged.

In certain implementations, the computing device 102 may be further configured to trigger enhanced monitoring for user activity associated with an entitlement assignment 111 identified in the entitlement recommendation 126. For example, if an entitlement is flagged as potentially inappropriate or high-risk for a user, the computing device 102 may signal other security systems to increase scrutiny on that user's actions when utilizing that specific entitlement. Enhanced monitoring could involve increasing the logging level for related events within a Security Information and Event Management (SIEM) system, configuring real-time alerts for specific sensitive actions performed using the flagged entitlement, or requiring more detailed session recording. This requires integration between the computing device 102 and the relevant enterprise monitoring infrastructure.

In certain implementations, the computing device 102 may be further configured to require or output a requirement for step-up authentication for access related to an entitlement assignment 111 identified in the entitlement recommendation 126. Step-up authentication may refer to requiring an additional layer of verification beyond the user's standard login credentials when they attempt to access or use a resource associated with a flagged entitlement. This could involve prompting for Multi-Factor Authentication (MFA), requiring approval from a manager or resource owner in real-time, or invoking other strong authentication mechanisms. This may be triggered when a policy enforcement point (e.g., within an Identity and Access Management (IAM) or Privileged Access Management (PAM) system) intercepts the access attempt and checks against the recommendations or risk scores generated by the computing device 102. Integration with the authentication and authorization infrastructure is necessary to implement this response.

In certain implementations, the computing device 102 may be further configured to initiate an automated remediation action based on the entitlement recommendation 126. Depending on configured policies and the confidence level derived from the combined anomaly measure 124, the computing device 102 may automatically take corrective action. The automated remediation action may include de-provisioning an entitlement identified as a high-confidence outlier (e.g., making an API call to Active Directory to remove a user from a group, submitting a request to an IDM system to revoke an application role). Conversely, based on suggestions derived from inlier analysis (as described earlier), the automated action might involve provisioning a likely needed entitlement (e.g., adding a user to a standard group for their role). Such automated actions typically require careful configuration, potentially including high confidence thresholds, approval workflows for certain actions, and robust error handling.

In certain implementations, the computing device 102 may be further configured to generate a report detailing entitlement assignments 111 identified based on the combined anomaly measures 124. These reports provide a documented summary of the analysis findings for various stakeholders. Reports might be generated in formats like PDF, CSV, or presented via an interactive HTML dashboard. The reports may include one or more of lists of outlier assignments and associated users, lists of suggested entitlements (inliers), the confidence scores or combined anomaly measures 124 supporting the findings, relevant user features 114 that contributed to the assessment, historical trends if available, and comparisons with peer groups.

In certain implementations, the determination of the entitlement recommendation 126 may be performed in response to receiving an access request for a new entitlement assignment 111. For instance, when a user or manager submits a request for access, the computing device 102 may be configured to simulate the state where the user is granted the requested entitlement. The computing device 102 may then executes the iterative anomaly analysis method on this simulated state. Based on the resulting combined anomaly measure 124 for the requested assignment in the context of the user's other attributes and entitlements, the system determines a recommendation 126 regarding the normalcy or anomalousness of the request (e.g., Request appears normal based on peers or Request flagged as highly anomalous, requires further review). This indication is then provided back to the access request workflow system or directly to the human approver, informing their decision.

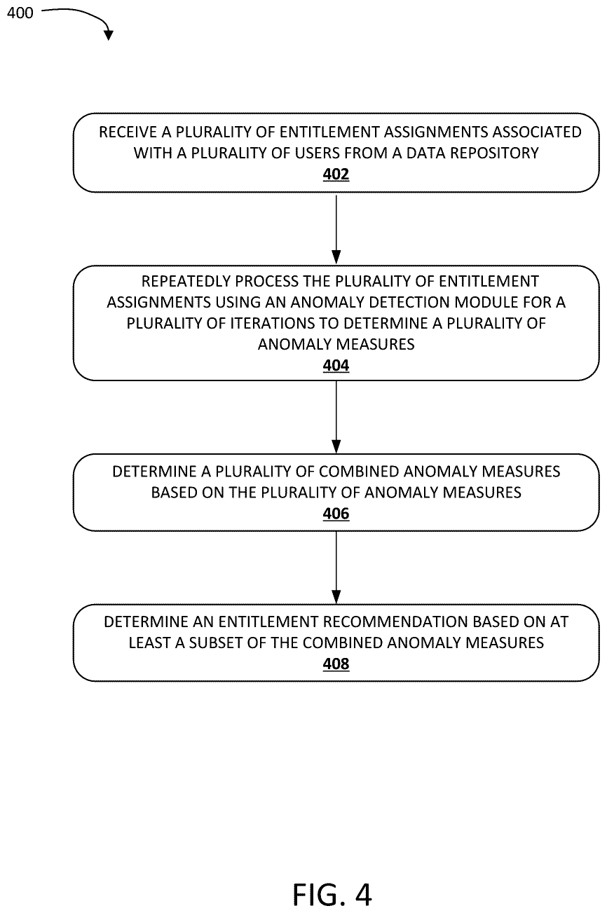

FIG. 4 depicts a method 400 for user entitlement analysis according to one aspect of the present disclosure. The method 400 may be implemented on a computer system, such as the system 100. For example, the method 400 may be implemented by the computing device 102. The method 400 may also be implemented by a set of instructions stored on a computer readable medium that, when executed by a processor, cause the computing device to perform the method 400. For example, all or part of the method 400 may be implemented by the processor 106 and the memory 108. Although the examples below are described with reference to the flowchart illustrated in FIG. 4, many other methods of performing the acts associated with FIG. 4 may be used. For example, the order of some of the blocks may be changed, certain blocks may be combined with other blocks, one or more of the blocks may be repeated, and some of the blocks may be optional.

At block 402, the method 400 may include receiving, by a computing device, a plurality of entitlement assignments associated with a plurality of users from a data repository. For example, the computing device 102 may receive a plurality of stored entitlement assignments 111 associated with a plurality of users from a data repository 104. In certain implementations, the method 400 may further include receiving, by the computing device 102, user profile data 113 associated with the plurality of users from the data repository 104, where the user profile data 113 includes a plurality of user features 114.

At block 404, the method 400 may include repeatedly processing, by the computing device, the plurality of entitlement assignments using an anomaly detection module for a plurality of iterations, to determine a plurality of anomaly measures. For example, the computing device 102 may repeatedly process the plurality of stored entitlement assignments 111 using an anomaly detection module 120 for a plurality of iterations, to determine a plurality of anomaly measures 122. Each respective anomaly measure 122 of the plurality of anomaly measures may correspond to a respective iteration of the anomaly detection module 120 and a respective entitlement assignment 111 of the plurality of entitlement assignments. In certain implementations, repeatedly processing the plurality of entitlement assignments 111 for the plurality of iterations may include, for each respective iteration of the plurality of iterations, applying the anomaly detection module 120 to the plurality of entitlement assignments 111 to determine a corresponding subset of the plurality of anomaly measures 122. In such instances, each respective anomaly measure 122 of the corresponding subset may thus be associated with the respective iteration and a respective entitlement assignment 111 of the plurality of entitlement assignments. The plurality of iterations may include a predetermined number of iterations, N, where N is greater than one, such as N being at least 5, or N being at least 10.

In certain implementations, the anomaly detection module 120 may include one or more machine learning models 130, and applying the anomaly detection module 120 to the plurality of entitlement assignments 111 during each respective iteration may include providing the plurality of entitlement assignments 111 as input to the one or more machine learning models 130. The one or more machine learning models 130 may include an unsupervised anomaly detection model. For instance, the unsupervised anomaly detection model may be an isolation forest model 130.

In implementations where user profile data 113 is also received, repeatedly processing the plurality of entitlement assignments 111 may further include processing the plurality of entitlement assignments 111 and the plurality of user features 114 using the anomaly detection module 120 to determine the plurality of anomaly measures 122. The plurality of user features 114 may include one or more of: a user role, a user team membership, a user manager identity, a user business unit affiliation, a user location, or a combination thereof. Additionally or alternatively, the plurality of user features 114 may include other entitlement assignments 111 associated with the plurality of users. The method 400 may further include determining feature weights for different user features 114 of the plurality of user features; and repeatedly processing the plurality of entitlement assignments 111 using the anomaly detection module 120 may include applying the feature weights during the processing.

At block 406, the method 400 may include determining, by the computing device, a plurality of combined anomaly measures based on the plurality of anomaly measures. For example, the computing device 102 may determine a plurality of combined anomaly measures 124 based on the plurality of anomaly measures 122. Each respective combined anomaly measure 124 of the plurality of combined anomaly measures may correspond to a respective entitlement assignment 111 of the plurality of entitlement assignments and may be determined based on anomaly measures 122 of the plurality of anomaly measures that correspond to the respective entitlement assignment 111. In certain implementations, determining each respective combined anomaly measure 124 may include combining a corresponding subset of the plurality of anomaly measures 122 and the corresponding subset may include anomaly measures 122 determined across the plurality of iterations for the respective entitlement assignment 111.

Different methods may be used for combining the corresponding subset. For instance, combining the corresponding subset of the plurality of anomaly measures 122 may include determining a sum of the anomaly measures 122 in the corresponding subset. Alternatively, combining the corresponding subset of the plurality of anomaly measures 122 may include determining an average of the anomaly measures 122 in the corresponding subset. In another approach, each anomaly measure 122 may indicate whether the respective entitlement assignment 111 was identified as anomalous in the respective iteration, and combining the corresponding subset may include determining a count of anomaly measures 122 within the corresponding subset that indicate the respective entitlement assignment 111 was identified as anomalous.

At block 408, the method 400 may include determining an entitlement recommendation based on at least a subset of the combined anomaly measures. For example, the computing device 102 may determine an entitlement recommendation 126 based on at least a subset of the combined anomaly measures 124. In certain implementations, determining the entitlement recommendation 126 may include determining a confidence score for one or more entitlement assignments 111 based on the combined anomaly measures 124. Alternatively or additionally, determining the entitlement recommendation 126 may include identifying one or more entitlement assignments 111 as potentially inappropriate based on the combined anomaly measures 124 exceeding a predetermined threshold. Determining the entitlement recommendation 126 may also include identifying one or more users associated with potentially inappropriate entitlement assignments 111 based on the combined anomaly measures 124.

The method 400 may further include determining, based on the combined anomaly measures 124, one or more inlier entitlement assignments that are identified as non-anomalous across the plurality of iterations; and determining a suggestion for a missing entitlement for a target user based on comparing entitlement assignments 111 of the target user to the one or more inlier entitlement assignments associated with peer users. In some implementations, determining the entitlement recommendation 126 may be performed in response to receiving an access request for a new entitlement assignment 111, and the method 400 may further include providing an indication of whether the requested new entitlement assignment 111 is anomalous based on the entitlement recommendation 126.

The method 400 may also include one or more additional actions performed based on the determined entitlement recommendation 126. For example, the method 400 may further include generating an alert notification based on the entitlement recommendation 126. The method 400 may further include triggering enhanced monitoring for user activity associated with an entitlement assignment 111 identified in the entitlement recommendation 126. Additionally, the method 400 may further include requiring step-up authentication for access related to an entitlement assignment 111 identified in the entitlement recommendation 126. In certain implementations, the method 400 may further include initiating an automated remediation action based on the entitlement recommendation 126, where the automated remediation action includes at least one of provisioning or de-provisioning an entitlement assignment 111 identified in the entitlement recommendation 126. Furthermore, the method 400 may further include generating a report detailing entitlement assignments 111 identified based on the combined anomaly measures 124.

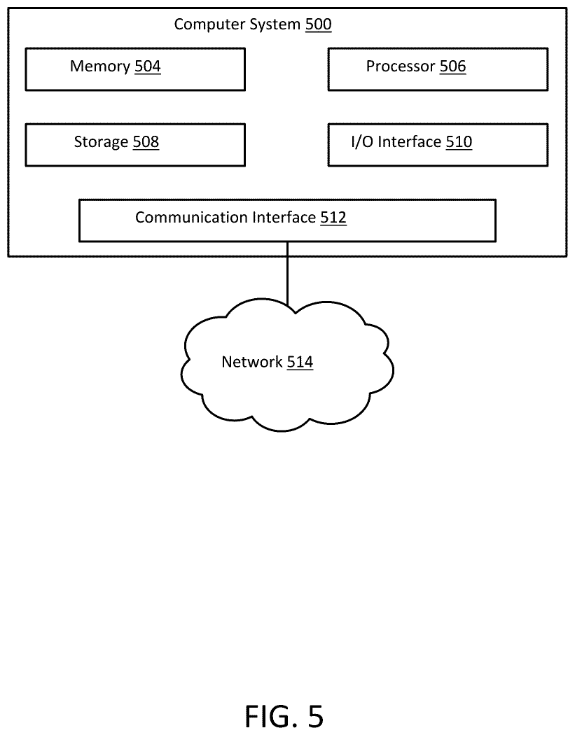

FIG. 5 illustrates an example computer system 500 that may be utilized to implement one or more of the devices and/or components discussed herein, such as the computing device 102, data store 104, or a combination thereof involved in the analysis of user entitlements. In particular embodiments, one or more computer systems 500 perform one or more steps of one or more methods described or illustrated herein, such as the method 400 for receiving entitlement data, repeatedly processing the data using an anomaly detection module over multiple iterations, determining combined anomaly measures, and determining entitlement recommendations. In particular embodiments, one or more computer systems 500 provide the functionalities described or illustrated herein, including executing the anomaly detection module 120 and associated machine learning models 130. In particular embodiments, software running on one or more computer systems 500 performs one or more steps of one or more methods described or illustrated herein or provides the functionalities described or illustrated herein. Particular embodiments include one or more portions of one or more computer systems 500. Herein, a reference to a computer system may encompass a computing device, and vice versa, where appropriate. Moreover, a reference to a computer system may encompass one or more computer systems, where appropriate.

This disclosure contemplates any suitable number of computer systems 500. This disclosure contemplates the computer system 500 taking any suitable physical form. As example and not by way of limitation, the computer system 500 may be an embedded computer system, a system-on-chip (SOC), a single-board computer system (SBC) (such as, for example, a computer-on-module (COM) or system-on-module (SOM)), a desktop computer system, a laptop or notebook computer system, an interactive kiosk, a mainframe, a mesh of computer systems, a mobile telephone, a personal digital assistant (PDA), a server, or a cluster of servers (such as cloud-based severs) suitable for handling large-scale data processing and machine learning tasks associated with entitlement analysis, a tablet computer system, an augmented/virtual reality device, or a combination of two or more of these. Where appropriate, the computer system 500 may include one or more computer systems 500; be unitary or distributed; span multiple locations; span multiple machines; span multiple data centers; or reside in a cloud, which may include one or more cloud components in one or more networks. Where appropriate, one or more computer systems 500 may perform without substantial spatial or temporal limitation one or more steps of one or more methods described or illustrated herein. As an example and not by way of limitation, one or more computer systems 500 may perform in real time (e.g., for analyzing access requests) or in batch mode (e.g., for periodic entitlement reviews) one or more steps of one or more methods described or illustrated herein. One or more computer systems 500 may perform at different times or at different locations one or more steps of one or more methods described or illustrated herein, where appropriate.

In particular embodiments, computer system 500 includes a processor 506, memory 504, storage 508, an input/output (I/O) interface 510, and a communication interface 512. Although this disclosure describes and illustrates a particular computer system having a particular number of particular components in a particular arrangement, this disclosure contemplates any suitable computer system having any suitable number of any suitable components in any suitable arrangement.

In particular embodiments, the processor 506 includes hardware for executing instructions, such as those making up a computer program implementing, for example, the anomaly detection module 120 or parts of method 400. As an example and not by way of limitation, to execute instructions, the processor 506 may retrieve (or fetch) the instructions from an internal register, an internal cache, memory 504, or storage 508; decode and execute the instructions (e.g., instructions for applying a machine learning model 130, calculating combined anomaly measures 124, or determining recommendations 126); and then write one or more results (e.g., anomaly measures 122, combined anomaly measures 124) to an internal register, internal cache, memory 504, or storage 508. In particular embodiments, the processor 506 may include one or more internal caches for data, instructions, or addresses. This disclosure contemplates the processor 506 including any suitable number of any suitable internal caches, where appropriate. As an example and not by way of limitation, the processor 506 may include one or more instruction caches, one or more data caches, and one or more translation lookaside buffers (TLBs). Instructions in the instruction caches may be copies of instructions in memory 504 or storage 508, and the instruction caches may speed up retrieval of those instructions by the processor 506. Data in the data caches may be copies of data in memory 504 or storage 508 that are to be operated on by computer instructions (e.g., entitlement assignments 111, user features 114); the results of previous instructions executed by the processor 506 that are accessible to subsequent instructions (e.g., anomaly measures 122 from one iteration used to calculate combined measures 124) or for writing to memory 504 or storage 508; or any other suitable data.

The data caches may speed up read or write operations by the processor 506. The TLBs may speed up virtual-address translation for the processor 506. In particular embodiments, processor 506 may include one or more internal registers for data, instructions, or addresses. This disclosure contemplates the processor 506 including any suitable number of any suitable internal registers, where appropriate. Where appropriate, the processor 506 may include one or more arithmetic logic units (ALUs), be a multi-core processor (potentially beneficial for parallelizing iterations or processing data subsets), include specialized hardware accelerators (e.g., GPUs or TPUs) for computationally intensive machine learning tasks, or include one or more processors 506. Although this disclosure describes and illustrates a particular processor, this disclosure contemplates any suitable processor.

In particular embodiments, the memory 504 includes main memory for storing instructions for the processor 506 to execute or data for processor 506 to operate on. As an example, and not by way of limitation, computer system 500 may load instructions (e.g., for the anomaly detection module 120) from storage 508 or another source (such as another computer system 500) to the memory 504. The processor 506 may then load the instructions from the memory 504 to an internal register or internal cache. To execute the instructions, the processor 506 may retrieve the instructions from the internal register or internal cache and decode them. During or after execution of the instructions, the processor 506 may write one or more results (which may be intermediate or final results, such as anomaly measures 122 or combined anomaly measures 124) to the internal register or internal cache. The processor 506 may then write one or more of those results to the memory 504. In particular embodiments, the processor 506 executes only instructions in one or more internal registers or internal caches or in memory 504 (as opposed to storage 508 or elsewhere) and operates only on data in one or more internal registers or internal caches or in memory 504 (as opposed to storage 508 or elsewhere). One or more memory buses (which may each include an address bus and a data bus) may couple the processor 506 to the memory 504. The bus may include one or more memory buses, as described in further detail below. In particular embodiments, one or more memory management units (MMUs) reside between the processor 506 and memory 504 and facilitate accesses to the memory 504 requested by the processor 506. In particular embodiments, the memory 504 includes random access memory (RAM). This RAM may be volatile memory, where appropriate. Where appropriate, this RAM may be dynamic RAM (DRAM) or static RAM (SRAM). Moreover, where appropriate, this RAM may be single-ported or multi-ported RAM. Given the potential for large datasets (entitlements 111, user profiles 113) and intermediate results (anomaly measures 122), substantial RAM capacity may be advantageous for efficient processing. This disclosure contemplates any suitable RAM. Memory 504 may include one or more memories 504, where appropriate. Although this disclosure describes and illustrates particular memory implementations, this disclosure contemplates any suitable memory implementation.

In particular embodiments, the storage 508 includes mass storage for data or instructions. As an example and not by way of limitation, the storage 508 may include a hard disk drive (HDD), a floppy disk drive, flash memory, an optical disc, a magneto-optical disc, magnetic tape, or a Universal Serial Bus (USB) drive or a combination of two or more of these. Storage 508 may be used to persistently store the received entitlement assignments 111, user profile data 113, configuration parameters 118, determined combined anomaly measures 124, generated entitlement recommendations 126, historical analysis results, or software modules including the anomaly detection module 120 and machine learning models 130. The storage 508 may include removable or non-removable (or fixed) media, where appropriate. The storage 508 may be internal or external to computer system 500, where appropriate. For example, storage 508 might represent the data store 104 or parts thereof. In particular embodiments, the storage 508 is non-volatile, solid-state memory. In particular embodiments, the storage 508 includes read-only memory (ROM). Where appropriate, this ROM may be mask-programmed ROM, programmable ROM (PROM), erasable PROM (EPROM), electrically erasable PROM (EEPROM), electrically alterable ROM (EAROM), or flash memory or a combination of two or more of these. This disclosure contemplates mass storage 508 taking any suitable physical form. The storage 508 may include one or more storage control units facilitating communication between processor 506 and storage 508, where appropriate. Where appropriate, the storage 508 may include one or more storages 508. Although this disclosure describes and illustrates particular storage, this disclosure contemplates any suitable storage.

In particular embodiments, the I/O Interface 510 includes hardware, software, or both, providing one or more interfaces for communication between computer system 500 and one or more I/O devices. The computer system 500 may include one or more of these I/O devices, where appropriate. One or more of these I/O devices may enable communication between a person (i.e., a user, such as an administrator configuring the system or reviewing entitlement recommendations) and computer system 500. As an example and not by way of limitation, an I/O device may include a keyboard, keypad, microphone, monitor, screen, display panel (e.g., for displaying reports or dashboards based on recommendation 126), mouse, printer, scanner, speaker, still camera, stylus, tablet, touch screen, trackball, video camera, another suitable I/O device or a combination of two or more of these. An I/O device may include one or more sensors. Where appropriate, the I/O Interface 510 may include one or more device or software drivers enabling processor 506 to drive one or more of these I/O devices. The I/O interface 510 may include one or more I/O interfaces 510, where appropriate. Although this disclosure describes and illustrates a particular I/O interface, this disclosure contemplates any suitable I/O interface or combination of I/O interfaces.

In particular embodiments, communication interface 512 includes hardware, software, or both providing one or more interfaces for communication (such as, for example, packet-based communication) between computer system 500 and one or more other computer systems 500 or one or more networks 514. For example, communication interface 512 may be used by computing device 102 to receive entitlement assignments 111 and user profile data 113 from remote data repositories 104, or to send entitlement recommendations 126, alerts, or remediation commands to other enterprise systems (e.g., SIEM, ITSM, IAM platforms) via network 514. As an example and not by way of limitation, communication interface 512 may include a network interface controller (NIC) or network adapter for communicating with an Ethernet or any other wire-based network or a wireless NIC (WNIC) or wireless adapter for communicating with a wireless network, such as a Wi-Fi network. This disclosure contemplates any suitable network 514 and any suitable communication interface 512 for the network 514. As an example and not by way of limitation, the network 514 may include one or more of an ad hoc network, a personal area network (PAN), a local area network (LAN), a wide area network (WAN), a metropolitan area network (MAN), or one or more portions of the Internet or a combination of two or more of these. One or more portions of one or more of these networks may be wired or wireless. As an example, computer system 500 may communicate with a wireless PAN (WPAN) (such as, for example, a Bluetooth® WPAN), a WI-FI network, a WI-MAX network, a cellular telephone network (such as, for example, a Global System for Mobile Communications (GSM) network), or any other suitable wireless network or a combination of two or more of these. Computer system 500 may include any suitable communication interface 512 for any of these networks, where appropriate. Communication interface 512 may include one or more communication interfaces 512, where appropriate. Although this disclosure describes and illustrates a particular communication interface implementations, this disclosure contemplates any suitable communication interface implementation.

The computer system 500 may also include a bus 502. The bus 502 may include hardware, software, or both and may communicatively couple the components of the computer system 500 to each other. As an example and not by way of limitation, the bus 502 may include an Accelerated Graphics Port (AGP) or any other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-PIN-count (LPC) bus, a memory bus, a Micro Channel Architecture (MCA) bus, a Peripheral Component Interconnect (PCI) bus, a PCI-Express (PCIe) bus, a serial advanced technology attachment (SATA) bus, a Video Electronics Standards Association local bus (VLB), or another suitable bus or a combination of two or more of these buses. The bus 502 may include one or more buses, where appropriate. Although this disclosure describes and illustrates a particular bus, this disclosure contemplates any suitable bus or interconnect.

Herein, a computer-readable non-transitory storage medium or media may include one or more semiconductor-based or other types of integrated circuits (ICs) (e.g., field-programmable gate arrays (FPGAs) or application-specific ICs (ASICs)), hard disk drives (HDDs), hybrid hard drives (HHDs), optical discs, optical disc drives (ODDs), magneto-optical discs, magneto-optical drives, floppy diskettes, floppy disk drives (FDDs), magnetic tapes, solid-state drives (SSDs), RAM-drives, SECURE DIGITAL cards or drives, any other suitable computer-readable non-transitory storage media, or any suitable combination of two or more of these, where appropriate. Such media may store instructions executable by processor 506 to perform steps of method 400 or implement modules like the anomaly detection module 120. A computer-readable non-transitory storage medium may be volatile, non-volatile, or a combination of volatile and non-volatile, where appropriate.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, features, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

All of the disclosed methods and procedures described in this disclosure can be implemented using one or more computer programs or components. These components may be provided as a series of computer instructions on any conventional computer readable medium or machine readable medium, including volatile and non-volatile memory, such as RAM, ROM, flash memory, magnetic or optical disks, optical memory, or other storage media. The instructions may be provided as software or firmware, and may be implemented in whole or in part in hardware components such as ASICs, FPGAs, DSPs, or any other similar devices. The instructions may be configured to be executed by one or more processors, which when executing the series of computer instructions, performs or facilitates the performance of all or part of the disclosed methods and procedures.

It should be understood that various changes and modifications to the examples described here will be apparent to those skilled in the art. Such changes and modifications can be made without departing from the spirit and scope of the present subject matter and without diminishing its intended advantages. It is therefore intended that such changes and modifications be covered by the appended claims.

1. A method comprising:
receiving, by a computing device, a plurality of entitlement assignments associated with a plurality of users from a data repository;
repeatedly processing, by the computing device, the plurality of entitlement assignments using an anomaly detection module for a plurality of iterations, to determine a plurality of anomaly measures, wherein each respective anomaly measure of the plurality of anomaly measures corresponds to a respective iteration of the anomaly detection module and a respective entitlement assignment of the plurality of entitlement assignments;
determining, by the computing device, a plurality of combined anomaly measures based on the plurality of anomaly measures, wherein each respective combined anomaly measure of the plurality of combined anomaly measures corresponds to a respective entitlement assignment of the plurality of entitlement assignments and is determined based on anomaly measures of the plurality of anomaly measures that correspond to the respective entitlement assignment; and
determining an entitlement recommendation based on at least a subset of the combined anomaly measures.

2. The method of claim 1, wherein repeatedly processing the plurality of entitlement assignments for the plurality of iterations comprises:
for each respective iteration of the plurality of iterations, applying the anomaly detection module to the plurality of entitlement assignments to determine a corresponding subset of the plurality of anomaly measures, wherein each respective anomaly measure of the corresponding subset is associated with the respective iteration and a respective entitlement assignment of the plurality of entitlement assignments.

3. The method of claim 2, wherein the anomaly detection module comprises one or more machine learning models, and wherein applying the anomaly detection module to the plurality of entitlement assignments during each respective iteration comprises providing the plurality of entitlement assignments as input to the one or more machine learning models.

4. The method of claim 2, wherein applying the anomaly detection module for the plurality of iterations comprises:
performing a first iteration by applying the anomaly detection module to the plurality of entitlement assignments to determine a first subset of the plurality of anomaly measures, wherein each anomaly measure in the first subset corresponds to the first iteration and a respective entitlement assignment of the plurality of entitlement assignments; and
performing a second iteration by applying the anomaly detection module to the plurality of entitlement assignments to determine a second subset of the plurality of anomaly measures, wherein each anomaly measure in the second subset corresponds to the second iteration and a respective entitlement assignment of the plurality of entitlement assignments.

5. The method of claim 3, wherein the one or more machine learning models comprise an unsupervised anomaly detection model.

6. The method of claim 5, wherein the unsupervised anomaly detection model comprises an Isolation Forest model.

7. The method of claim 1, wherein determining each respective combined anomaly measure comprises combining a corresponding subset of the plurality of anomaly measures, the corresponding subset comprising anomaly measures determined across the plurality of iterations for the respective entitlement assignment.

8. The method of claim 7, wherein determining the plurality of combined anomaly measures comprises:
determining a first combined anomaly measure for a first entitlement assignment of the plurality of entitlement assignments based on a first subset of the plurality of anomaly measures, wherein the first subset comprises anomaly measures associated with the first entitlement assignment determined across the plurality of iterations; and
determining a second combined anomaly measure for a second entitlement assignment of the plurality of entitlement assignments based on a second subset of the plurality of anomaly measures, wherein the second subset comprises anomaly measures associated with the second entitlement assignment determined across the plurality of iterations.

9. The method of claim 7, wherein combining the corresponding subset of the plurality of anomaly measures comprises:
determining a sum of the anomaly measures in the corresponding subset;
determining an average of the anomaly measures in the corresponding subset;
determining a count of anomaly measures within the corresponding subset that indicate the respective entitlement assignment was identified as anomalous; or
a combination thereof.

10. The method of claim 1, further comprising:
receiving, by the computing device, user profile data associated with the plurality of users from the data repository, the user profile data comprising a plurality of user features; and
wherein repeatedly processing the plurality of entitlement assignments further comprises processing the plurality of entitlement assignments and the plurality of user features using the anomaly detection module to determine the plurality of anomaly measures.

11. The method of claim 10, wherein the plurality of user features comprises one or more of: a user role, a user team membership, a user manager identity, a user business unit affiliation, or a user location.

12. The method of claim 10, further comprising:
determining feature weights for different user features of the plurality of user features; and
wherein repeatedly processing the plurality of entitlement assignments using the anomaly detection module comprises applying the feature weights during the processing.

13. The method of claim 1, wherein the plurality of iterations comprises a predetermined number of iterations, N, where N is greater than one.

14. The method of claim 1, further comprising:
determining, based on the combined anomaly measures, one or more inlier entitlement assignments that are identified as non-anomalous across the plurality of iterations; and
determining a suggestion for a missing entitlement for a target user based on comparing entitlement assignments of the target user to the one or more inlier entitlement assignments associated with peer users.

15. The method of claim 1, further comprising:
generating an alert notification based on the entitlement recommendation;
triggering enhanced monitoring for user activity associated with an entitlement assignment identified in the entitlement recommendation;
requiring step-up authentication for access related to an entitlement assignment identified in the entitlement recommendation;
initiating an automated remediation action based on the entitlement recommendation, the automated remediation action comprising at least one of provisioning or de-provisioning an entitlement assignment identified in the entitlement recommendation;
generating a report detailing entitlement assignments identified based on the combined anomaly measures; or
a combination thereof.

16. The method of claim 1, wherein determining the entitlement recommendation is performed in response to receiving an access request for a new entitlement assignment, the method further comprising:
providing an indication of whether the requested new entitlement assignment is anomalous based on the entitlement recommendation.

17. A system comprising:
a processor; and
a memory storing instructions which, when executed by the processor, cause the processor to perform operations including:
receiving, by a computing device, a plurality of entitlement assignments associated with a plurality of users from a data repository;
repeatedly processing, by the computing device, the plurality of entitlement assignments using an anomaly detection module for a plurality of iterations, to determine a plurality of anomaly measures, wherein each respective anomaly measure of the plurality of anomaly measures corresponds to a respective iteration of the anomaly detection module and a respective entitlement assignment of the plurality of entitlement assignments;
determining, by the computing device, a plurality of combined anomaly measures based on the plurality of anomaly measures, wherein each respective combined anomaly measure of the plurality of combined anomaly measures corresponds to a respective entitlement assignment of the plurality of entitlement assignments and is determined based on anomaly measures of the plurality of anomaly measures that correspond to the respective entitlement assignment; and
determining an entitlement recommendation based on at least a subset of the combined anomaly measures.

18. The system of claim 17, wherein repeatedly processing the plurality of entitlement assignments for the plurality of iterations comprises:
for each respective iteration of the plurality of iterations, applying the anomaly detection module to the plurality of entitlement assignments to determine a corresponding subset of the plurality of anomaly measures, wherein each respective anomaly measure of the corresponding subset is associated with the respective iteration and a respective entitlement assignment of the plurality of entitlement assignments.

19. The system of claim 17, wherein determining each respective combined anomaly measure comprises combining a corresponding subset of the plurality of anomaly measures, the corresponding subset comprising anomaly measures determined across the plurality of iterations for the respective entitlement assignment.

20. A non-transitory, computer-readable medium storing instructions which, when executed by a processor, cause the processor to perform operations, comprising:
receiving, by a computing device, a plurality of entitlement assignments associated with a plurality of users from a data repository;
repeatedly processing, by the computing device, the plurality of entitlement assignments using an anomaly detection module for a plurality of iterations, to determine a plurality of anomaly measures, wherein each respective anomaly measure of the plurality of anomaly measures corresponds to a respective iteration of the anomaly detection module and a respective entitlement assignment of the plurality of entitlement assignments;
determining, by the computing device, a plurality of combined anomaly measures based on the plurality of anomaly measures, wherein each respective combined anomaly measure of the plurality of combined anomaly measures corresponds to a respective entitlement assignment of the plurality of entitlement assignments and is determined based on anomaly measures of the plurality of anomaly measures that correspond to the respective entitlement assignment; and
determining an entitlement recommendation based on at least a subset of the combined anomaly measures.
